(19) United States
(12) Patent Application Publication
(10) Pub. No.: US 2025/0299477 A1
(43) Pub. Date: Sep. 25, 2025

(54) ARTIFICIAL NEURAL NETWORK WITH HOUGH-TO-RADON TRANSFORM LAYER FOR FEATURES IMPROVEMENT IN PROJECTION SPACE

(71) Applicant: Smart Engines Service, LLC, Moscow (RU)

(72) Inventors: Alexandra Antonovna ZHABITSKAYA, Moscow (RU); Aleksandr Vladimirovich SHESHKUS, Stary Oskol (RU); Vladimir Lvovich ARLAZAROV, Moscow (RU)

(21) Appl. No.: 18/903,473

(22) Filed: Oct. 1, 2024

(30) Foreign Application Priority Data
Mar. 25, 2024 (RU) 2024107735

(51) Int. Cl. G06V 10/82; G06V 10/26; G06V 30/416

(52) U.S. Cl. CPC G06V 10/82; G06V 10/26; G06V 30/416

(57) ABSTRACT

While convolutional neural networks have been prized for image-processing tasks, they have limitations. Embodiments introduce a new Hough-to-Radon Transform (HRT) layer into an artificial neural network, such as a convolutional neural network, to address one or more of these limitations, without compromising on the accuracy of the artificial neural network for image-processing tasks. The HRT layer converts an input image from a first parameter space into a second parameter space of reduced complexity. Inner layers may operate on the image in this second parameter space, instead of in the first parameter space, to reduce the overall computational cost of the artificial neural network.

### CROSS-REFERENCE TO RELATED APPLICATIONS

The present application claims priority to Russian Application No. 2024107735, filed on Mar. 25, 2024, which is hereby incorporated herein by reference as if set forth in full.

### BACKGROUND

### Field of the Invention

The embodiments described herein are generally directed to artificial neural networks, and, more particularly, to an artificial neural network that includes a new layer that implements a Hough-to-Radon transform for features improvement in projection space.

### Description of the Related Art

In the modern world, there is sustained interest in image processing, including image analysis. For instance, pattern recognition is a priority in the development of artificial intelligence (AI). Convolutional neural networks (CNNs) are one of various methods used for pattern recognition. As examples, convolutional neural networks are used in the classification of medical images (see, e.g., Ref1, Ref2), road signs (see, e.g., Ref3, Ref4), handwritten numbers (see, e.g., Ref5), and the like. Ref2 proposed a method to classify breast cancer tissues using a Squeeze-and-Excitation Residual Neural Network (SE-ResNet). Increasingly, convolutional neural networks are being developed for three-dimensional (3D) object detection (see, e.g., Ref6).

Convolutional layers have always been prized for their ability to process local features. Recently, however, a contrary view has developed. In Ref22, the authors claim that convolutional characteristics, which were once considered strengths, are now seen as limitations. In particular, there are three main issues. Firstly, convolutions process all image pixels, regardless of their importance and position. This leads to spatial inefficiency, particularly in image-segmentation tasks, in which certain image objects are prioritized over others. Secondly, high-level features may not always be present in an image, which makes the use of pre-trained feature filters inefficient. Thirdly, convolutions struggle to establish dependencies between distant pixels. Each convolutional filter is confined to operate within a small region, but long-range interactions between semantic concepts are crucial in some tasks. To handle spatially distant concepts, existing approaches increase the kernel size or model depth. However, this compensates for the weakness of convolutions by adding complexity to the model, which increases training time and computational resources.

These problems in convolutional neural networks encourage the use of artificial neural networks that rely on tools that operate with global features, rather than relying exclusively on convolutional features. Most new architectures are designed according to well-known models and are combinations of already studied layers. Searching and discovering new combinations is highly important in addressing a broader range of computer vision tasks.

### SUMMARY

Accordingly, systems, methods, and non-transitory computer-readable media are disclosed for an artificial neural network with a new network layer that implements a Hough-to-Radon transform for features improvement in projection space.

In an embodiment, a method comprises using at least one hardware processor to: construct an artificial neural network comprising a plurality of layers, wherein the plurality of layers comprises a Hough Transform (HT) layer that implements a Hough Transform to convert an image into a first parameter space, and a Hough-to-Radon Transform (HRT) layer that converts the image from the first parameter space into a second parameter space, wherein the first parameter space defines each line in the image using (s,t) coordinates, in which s is a coordinate of a first intersection of the line with a first boundary of the image that is parallel to an axis of the image, and t is a difference along the axis between the first intersection and a second intersection of the line with a second boundary of the image that is parallel to the axis, and wherein the second parameter space defines each line in the image using (ρ,φ) coordinates, in which ρ is a distance of the line from an origin point defined for the image, and φ is an angle of a normal slope of the line; and train the artificial neural network to perform an image-processing task.

The method may further comprise using the at least one hardware processor to deploy the trained artificial neural network to perform the image-processing task on each of a plurality of input images in a production environment. The method may further comprise using the at least one hardware processor to, after deploying the trained artificial neural network: receive one of the plurality of input images; apply the trained artificial neural network to the received input image to perform the image-processing task on the received input image; and provide an output of the trained artificial neural network to one or more downstream functions. The image-processing task may comprise image segmentation. The image segmentation may be semantic document segmentation. The artificial neural network may output a classification of each pixel in the input image into one of a plurality of classes, wherein the plurality of classes comprises a background class and a foreground class.

The HRT layer may immediately follow the HT layer in sequence from an input to an output of the artificial neural network.

The plurality of layers may further comprise a Radon-to-Hough Transform (RHT) layer that converts the image from the second parameter space to the first parameter space, and a Transposed Hough Transform (THT) layer that implements a Transposed Hough Transform, wherein the RHT layer follows the HRT layer in sequence from an input to an output of the artificial neural network. The THT layer may immediately follow the RHT layer in the sequence from the input to the output of the artificial neural network. The plurality of layers may further comprise one or more layers between the HRT layer and the RHT layer. Each of the one or more layers between the HRT layer and the RHT layer may be a convolutional layer. The plurality of layers may further comprise one or both of one or more layers before the HT layer, or one or more layers after the THT layer.

The Hough Transform may be a Fast Hough Transform.

The artificial neural network may be a convolutional neural network.

The HRT layer may generate an output image of a predefined size by, for each (ρ,φ) coordinate in the output image, setting a value of a pixel at that (ρ,φ) coordinate in the output image based on a value of a pixel at a corresponding (s,t) coordinate in an input image.

The predefined size may be defined by a height equal to a number of angles, acquired from a range of angles according to a step size, and a width equal to a maximum integer radius in the input image prior to application of the HT layer.

The (s,t) coordinates in the first parameter space may be mapped to (ρ,φ) coordinates in the second parameter space as follows:

$$t = - {w}_{1} \cdot tan ( - φ ) ,$$

$$s = \frac{ρ}{scaleX \cdot {w}_{1}} \cdot \sqrt{{t}^{2} + {w}_{1}^{2}} , when - 45 ° \leq φ < 45 °$$

$$t = - {w}_{1} / tan ( φ ) ,$$

$$s = \frac{ρ}{scaleX \cdot {w}_{1}} \cdot \sqrt{{t}^{2} + {w}_{1}^{2}} , when 45 ° \leq φ < 135 °$$

wherein w₁ is a width of the image, tan(·) is a tangent function, and scaleX is a scaling factor.

All operations in the HRT layer may be predefined and kept constant during the training of the artificial neural network.

It should be understood that any of the features in the methods above may be implemented individually or with any subset of the other features in any combination. Thus, to the extent that the appended claims would suggest particular dependencies between features, disclosed embodiments are not limited to these particular dependencies. Rather, any of the features described herein may be combined with any other feature described herein, or implemented without any one or more other features described herein, in any combination of features whatsoever. In addition, any of the methods, described above and elsewhere herein, may be embodied, individually or in any combination, in executable software modules of a processor-based system, such as a server, and/or in executable instructions stored in a non-transitory computer-readable medium.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates an example processing system, by which one or more of the processes described herein may be executed, according to an embodiment;

FIG. 2A illustrates a type of parameterization, according to an embodiment;

FIG. 2B illustrates a transition from one coordinate system to another coordinate system, according to an example;

FIG. 3 illustrates an example architecture of an artificial neural network, according to an embodiment;

FIGS. 4A and 4B represent example output images of a Hough Transform layer and a Hough-to-Radon Transform layer, respectively, according to an embodiment;

FIGS. 5A and 5B represent example output images of a Hough Transform layer and a Hough-to-Radon Transform layer, respectively, according to an embodiment;

FIG. 6 illustrates a process for training an artificial neural network, according to an embodiment;

FIG. 7 illustrates a process for operating an artificial neural network, according to an embodiment;

FIG. 8 is a table of experimental results, according to an implementation of an embodiment; and

FIGS. 9A-9D illustrate example results of semantic document segmentation, according to an embodiment.

### DETAILED DESCRIPTION

In an embodiment, systems, methods, and non-transitory computer-readable media are disclosed for an artificial neural network with a new layer that implements a Hough-to-Radon transform for features improvement in projection space. After reading this description, it will become apparent to one skilled in the art how to implement the invention in various alternative embodiments and alternative applications. However, although various embodiments of the present invention will be described herein, it is understood that these embodiments are presented by way of example and illustration only, and not limitation. As such, this detailed description of various embodiments should not be construed to limit the scope or breadth of the present invention as set forth in the appended claims.

### 1. Example Processing System

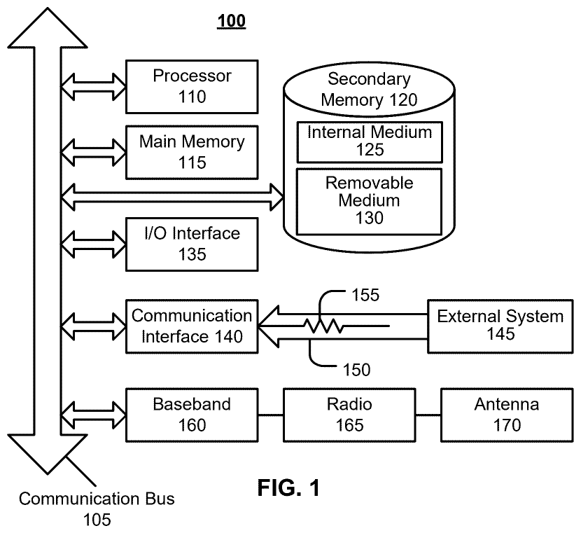

FIG. 1 is a block diagram illustrating an example wired or wireless processing system 100 that may be used in connection with various embodiments described herein. For example, system 100 may be used as or in conjunction with one or more of the processes, methods, or functions (e.g., to store and/or execute implementing software) described herein. System 100 can be any processor-enabled device (e.g., server, personal computer, etc.) that is capable of wired or wireless data communication. Other processing systems and/or architectures may also be used, as will be clear to those skilled in the art.

System 100 may comprise one or more processors 110. Processor(s) 110 may comprise a central processing unit (CPU). Additional processors may be provided, such as a graphics processing unit (GPU), an auxiliary processor to manage input/output, an auxiliary processor to perform floating-point mathematical operations, a special-purpose microprocessor having an architecture suitable for fast execution of signal-processing algorithms (e.g., digital-signal processor), a subordinate processor (e.g., back-end processor), an additional microprocessor or controller for dual or multiple processor systems, and/or a coprocessor. Such auxiliary processors may be discrete processors or may be integrated with a main processor 110. Examples of processors which may be used with system 100 include, without limitation, any of the processors (e.g., Pentium™, Core i7™, Xeon™, etc.) available from Intel Corporation of Santa Clara, California, any of the processors available from Advanced Micro Devices, Incorporated (AMD) of Santa Clara, California, any of the processors (e.g., A series, M series, etc.) available from Apple Inc. of Cupertino, any of the processors (e.g., Exynos™) available from Samsung Electronics Co., Ltd., of Seoul, South Korea, any of the processors available from NXP Semiconductors N.V. of Eindhoven, Netherlands, and/or the like.

Processor 110 may be connected to a communication bus 105. Communication bus 105 may include a data channel for facilitating information transfer between storage and other peripheral components of system 100. Furthermore, communication bus 105 may provide a set of signals used for communication with processor 110, including a data bus, address bus, and/or control bus (not shown). Communication bus 105 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPIB), IEEE 696/S-100, and/or the like.

System 100 may comprise main memory 115. Main memory 115 provides storage of instructions and data for programs executing on processor 110, such as one or more of the functions and/or modules discussed herein. It should be understood that programs stored in the memory and executed by processor 110 may be written and/or compiled according to any suitable language, including without limitation C/C++, Java, JavaScript, Perl, Python, Visual Basic, .NET, and the like. Main memory 115 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

System 100 may comprise secondary memory 120. Secondary memory 120 is a non-transitory computer-readable medium having computer-executable code and/or other data (e.g., any of the software disclosed herein) stored thereon. In this description, the term “computer-readable medium” is used to refer to any non-transitory computer-readable storage media used to provide computer-executable code and/or other data to or within system 100. The computer software stored on secondary memory 120 is read into main memory 115 for execution by processor 110. Secondary memory 120 may include, for example, semiconductor-based memory, such as programmable read-only memory (PROM), erasable programmable read-only memory (EPROM), electrically erasable read-only memory (EEPROM), and flash memory (block-oriented memory similar to EEPROM).

Secondary memory 120 may include an internal medium 125 and/or a removable medium 130. Internal medium 125 and removable medium 130 are read from and/or written to in any well-known manner. Internal medium 125 may comprise one or more hard disk drives, solid state drives, and/or the like. Removable storage medium 130 may be, for example, a magnetic tape drive, a compact disc (CD) drive, a digital versatile disc (DVD) drive, other optical drive, a flash memory drive, and/or the like.

System 200 may comprise an input/output (I/O) interface 135. I/O interface 135 provides an interface between one or more components of system 100 and one or more input and/or output devices. Example input devices include, without limitation, sensors, keyboards, touch screens or other touch-sensitive devices, cameras, biometric sensing devices, computer mice, trackballs, pen-based pointing devices, and/or the like. Examples of output devices include, without limitation, other processing systems, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and/or the like. In some cases, an input and output device may be combined, such as in the case of a touch panel display (e.g., in a smartphone, tablet computer, or other mobile device).

System 100 may comprise a communication interface 140. Communication interface 140 allows software to be transferred between system 100 and external devices (e.g. printers), networks, or other data sources and/or data destinations. For example, computer-executable code and/or data may be transferred to system 100, over one or more networks (e.g., including the Internet), from a network server via communication interface 140. Examples of communication interface 140 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 100 with a network or another computing device. Communication interface 140 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software transferred via communication interface 140 is generally in the form of electrical communication signals 155. These signals 155 may be provided to communication interface 140 via a communication channel 150 between communication interface 140 and an external system 145. In an embodiment, communication channel 150 may be a wired or wireless network, or any variety of other communication links. Communication channel 150 carries signals 155 and can be implemented using a variety of wired or wireless communication means including wire or cable, fiber optics, conventional phone line, cellular phone link, wireless data communication link, radio frequency (“RF”) link, or infrared link, just to name a few.

Computer-executable code is stored in main memory 115 and/or secondary memory 120. Computer-executable code can also be received from an external system 145 via communication interface 140 and stored in main memory 115 and/or secondary memory 120. Such computer-executable code, when executed, enable system 100 to perform one or more functions of the disclosed embodiments.

In an embodiment that is implemented using software, the software may be stored on a computer-readable medium and initially loaded into system 100 by way of removable medium 130, I/O interface 135, or communication interface 140. In such an embodiment, the software is loaded into system 100 in the form of electrical communication signals 155. The software, when executed by processor 110, preferably causes processor 110 to perform one or more functions of the disclosed embodiments.

System 100 may comprise wireless communication components that facilitate wireless communication over a voice network and/or a data network (e.g., in the case of a mobile device, such as a smart phone). The wireless communication components comprise an antenna system 170, a radio system 165, and a baseband system 160. In system 100, radio frequency (RF) signals are transmitted and received over the air by antenna system 170 under the management of radio system 165.

In an embodiment, antenna system 170 may comprise one or more antennae and one or more multiplexors (not shown) that perform a switching function to provide antenna system 170 with transmit and receive signal paths. In the receive path, received RF signals can be coupled from a multiplexor to a low noise amplifier (not shown) that amplifies the received RF signal and sends the amplified signal to radio system 165.

In an alternative embodiment, radio system 165 may comprise one or more radios that are configured to communicate over various frequencies. In an embodiment, radio system 165 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 165 to baseband system 160.

If the received signal contains audio information, then baseband system 160 decodes the signal and converts it to an analog signal. Then the signal is amplified and sent to a speaker. Baseband system 160 also receives analog audio signals from a microphone. These analog audio signals are converted to digital signals and encoded by baseband system 160. Baseband system 160 also encodes the digital signals for transmission and generates a baseband transmit audio signal that is routed to the modulator portion of radio system 165. The modulator mixes the baseband transmit audio signal with an RF carrier signal, generating an RF transmit signal that is routed to antenna system 170 and may pass through a power amplifier (not shown). The power amplifier amplifies the RF transmit signal and routes it to antenna system 170, where the signal is switched to the antenna port for transmission.

Baseband system 160 is communicatively coupled with processor(s) 110, which have access to memory 115 and 120. Thus, software can be received from baseband processor 160 and stored in main memory 110 or in secondary memory 120, or executed upon receipt. Such software, when executed, can enable system 100 to perform one or more functions of the disclosed embodiments.

### 2. Hough Transform

The Hough Transform (HT) is one tool for image analysis (see, e.g., Ref9). In the (x,y) coordinate space, a line is defined by the slope a and the shift s along the ordinate axis:

$$y = t g ( α ) x + s$$

In a mapping between (x,y) and (s,α) coordinate spaces, a straight line in (x,y) space may be mapped to a point with coordinates (s,α). In more detail, if points form any line in (x,y) space, the intersection of Hough lines in the points image provides the desired (s,α) coordinates in the Hough space. Each point (s,α) in the Hough space is an integral of the pixel intensity along the direction corresponding to the angle α and the shift s in the (x,y) space. The Hough Transform H can be defined using the following formula:

$$H ( s , α ) = {\sum }_{( x , y ) ∈ l ( s , α )} I ( x , y )$$

wherein I represents the image, and l(s,α) is a line in the (x,y) space with angle α and shift s.

Over time, a number of modifications have been made to the original Hough Transform, which have significantly changed the appearance and structure of the image that is output by the Hough Transform. As discussed in Ref11, originally, the Hough Transform was only applied to a fragment of an input image, but, when analyzing real data, this approach is inconvenient. In particular, to span the entire image area that includes lines, the authors of Ref11 proposed expanding the original input image by h×h or w×w, where h and w represent the height and width of the input image, respectively.

The classical Hough Transform has a complexity of O(n²), wherein n is the size of the input image. This complexity limits the applicability of the Hough Transform with respect to large datasets. The Fast Hough Transform (FHT) provides a solution. Operating with dyadic patterns, the Fast Hough Transform reduces the complexity to linear-logarithmic O(n log n). The idea is to split the input image into two halves using a bit-shift operation, and then individually apply the Fast Hough Transform to each half. While this method efficiently utilizes the input image's periodicity and symmetry to enhance the computational speed, it requires the range of angles to be divided into four parts, since performing the Fast Hough Transformation for only one angular range (i.e., one quadrant) is insufficient for a full analysis of the input image.

Ref12 suggests a method of combining image quadrants based on their common edge regions. When combining the image quadrants, a common line is subtracted, in order to “glue” the image quadrants together. Thus, the output image of such a transformation for all four quadrants will have a height of 4×h−3. For complete data analysis, it is convenient to use a version of the Hough Transform that receives an image of size h×h and produces an image of size (h×h)×(4×h−3) for square input images having a size that is a degree of two. As a result, the area of the feature maps expands by a factor of approximately eight, which leads to a considerable increase in the cost of computing convolutional layers on the feature maps. The neural network architecture in Ref15 is particularly affected by this problem, since the inner convolutions, between the FHT layer and Transposed Fast Hough Transform (TFHT) layer, operate with enlarged feature maps.

Using the Hough Transform as an inner layer for intermediate feature maps is a new trend in developing neural network architectures. For instance, Ref19 applied the Hough Transform before training a hierarchical neural network for character recognition, Ref7 created a HoughNet architecture, based on the Hough Transform, to detect vanishing points outside the input image, Ref18 utilized the Hough Transform in the development of a neural network for human eye recognition, and Ref10 applied the Hough Transform for semantic document segmentation.

In architectures that incorporate an HT layer, post-HT convolutions are required to extract complex non-linear features along various straight lines. The Hough Transform converts the input image into a parameter space with new coordinates, thereby modifying the size of the image. Assuming a significant increase in the area of the input image, post-HT convolutions become computationally expensive. Thus, the issue of image size is quite acute.

There is another factor that reveals the imperfections of the Hough Transform in convolutional networks. In the real coordinate plane (i.e., R²), any straight line can be uniquely determined by two parameters.

A first type of parameterization defines a straight line using the coordinates (s,t). For mostly horizontal lines (i.e., 45°≤φ<135°, these parameters specify the y-coordinate of the intersection of the line with the left or right boundary of the input image and its variation between the left and the right boundaries of the input image, respectively. For mostly vertical lines (i.e., −45°≤φ<45°, these parameters specify the x-coordinate of the intersection of the line with the top or bottom boundary of the input image and its variation between the top and the bottom boundaries of the input image, respectively. More generally, the (s,t) parameter space defines each line in an image using coordinates (s,t), in which s is a coordinate of a first intersection of the line with a first boundary of the input image that is parallel to an axis (e.g., x-axis or y-axis) of the image, and t is a difference along that same axis between the first intersection and a second intersection of the line with a second boundary of the image that is parallel to that same axis, and also parallel to the first boundary on an opposite side of the image as the first boundary. The (s,t) plane defines a first parameter space for the set of lines.

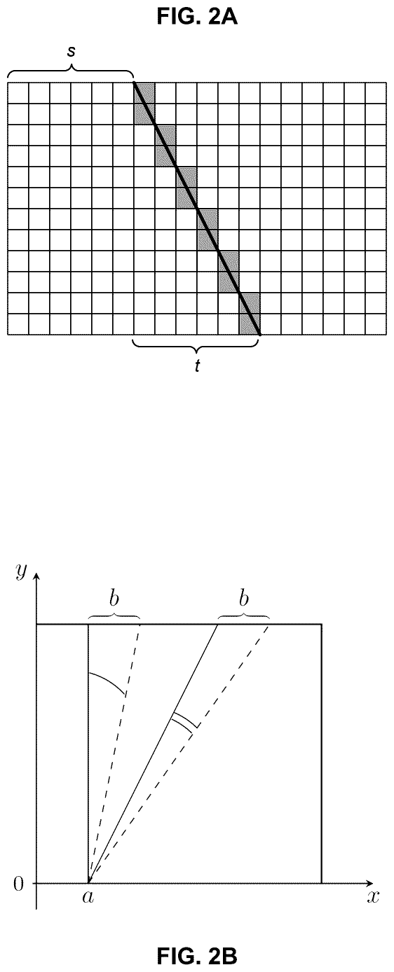

FIG. 2A illustrates the first type of parameterization to the (s,t) parameter space, according to an example. A mostly vertical line with a slope to the right (i.e., −45°≤φ<0°) is illustrated. As shown, the parameter s is determined as the x-coordinate of the intersection of the line with the top boundary of the input image, and the parameter t is determined as the variation of the line between the top and bottom boundaries, which may be defined as the difference between the x-coordinate of the intersection of the line with the top boundary and the x-coordinate of the intersection of the line with the bottom boundary. In the illustrated example, s=6 and t=6, for a parameterization of the line to (6, 6).

In a second type of parameterization, a straight line is specified by the angle φ of its normal slope (cos φ, sin φ) to the x-axis, which is in contrast to α (i.e., an angle between the line itself and the x-axis), and the distance p of the line from an origin point defined for the input image. The (ρ,φ) plane defines a second parameter space for the set of lines.

For an input image that has a size of w₁×w₁, the following relationship exists between the (s,t) parameter space and the (ρ,φ) parameter space (see, e.g., Ref16):

$$tan ( p \cdot φ ) = - {( \frac{{w}_{1}}{t} )}^{p}$$

$$ρ = \frac{s \cdot {w}_{1}}{\sqrt{{t}^{2} + {w}_{1}^{2}}}$$

wherein tan (·) is the tangent function, p=1 for mostly horizontal lines, and p=−1 for mostly vertical lines.

FIG. 2B illustrates that the transition from one coordinate system to another coordinate system is non-linear in terms of both angle and shift, according to an example. In particular, two pairs of lines, having the same (a,b) change, correspond to different angles. This non-linearity is bad for convolutions that rely on the size of the feature elements in feature maps (see, e.g., Ref21).

### 3. Hough-to-Radon Transform

In an embodiment, a new layer is added to the architecture of an artificial neural network during construction of the artificial neural network. This new layer performs a conversion from the (s,t) parameter space, which may also be referred to herein as “the first parameter space,” to the (ρ,φ) parameter space, which may also be referred to herein as “the second parameter space.” This new layer will be referred to herein as the Hough-to-Radon Transform (HRT) layer. The HRT layer addresses the high computational cost of convolutional layers after the Hough Transform and the non-linearity of image coordinates in terms of angle and shift, without compromising the performance of the artificial neural network.

First, the principle of converting an image from the (s,t) parameter space to the (ρ,φ) parameter space and back will be described. For the sake of simplicity, only square input images, with sides having a length that is a degree of two, are considered. However, it should be understood that the disclosed embodiments may be extended to input images of any arbitrary size, including non-square input images and input images with sides whose lengths are not a degree of two, without modification.

Second, the layout of the output image will be detailed. The output image has a width w₂ and a height h₂, for an FHT input image having a size of w₁×w₁. The input parameter of the Hough-to-Radon Transform is the number of angles, which is denoted as n. As mentioned above, the image produced by the Fast Hough Transform consists of four regions: mostly vertical lines with a slope to the right (i.e., −45°≤φ<0°); mostly vertical lines with a slope to the left (i.e., 0°≤φ<45°); mostly horizontal lines with a slope downwards (i.e., 45°≤φ<90°); and mostly horizontal lines with a slope upwards (i.e., 90°≤φ<135°). The range of angles [−45°; 135°] are iterated over, with a step size of 180/n, which creates a list of angles, arranged in ascending order, denoted by A. Each angle in the list of angles corresponds to one horizontal line in the output image. In other words, the height h₂ of the output image is equal to n (i.e., h₂=n). The width w₂ of the output image is assumed to be equal to the maximum integer radius in the input image, prior to application of the Fast Hough Transform (i.e., w₂=\sqrt{2w₁²}).

The Hough-to-Radon Transform is performed by iterating over the coordinates in the output image, which ensures that there will be no missing pixels in the output image. An image pixel in the output image is defined by coordinates (i,j), where i ranges from zero to w², and j ranges from zero to h₂, with both i and j being positive integers. Let p=i and φ be the j-th element in the ordered list A. For each and every such (ρ,φ) coordinate, a corresponding (s,t) coordinate is found, the value of a pixel at the corresponding (s,t) coordinate in the input image is retrieved, and the value of the pixel at the (ρ,φ) coordinate is set based on the retrieved value of the corresponding (s,t) coordinate.

In an embodiment, a scaling factor scaleX is introduced, to enable the size of the output image to be adjusted without having to change the value of n. In particular, scaleX controls the width w₂ of the output image. Iterating through the (i,j) coordinates of the output image, which is now of size (w₂×scaleX)×h₂, each (i,j) coordinate is set to the value from the corresponding (s,t) coordinate in the input image for the (i/scaleX, j) coordinate. Since the pixel values are discrete, the acquired values are rounded to the nearest integers (s,t). This scaling is kept simple, because it is assumed that convolutional layers themselves learn through local window filters. This approach enables the image to be conveniently scaled to adjust the size of the output image, which provides a further reduction in the computational (e.g., processing and memory) requirements of the model.

Considering the relationship between the parameter spaces (s,t) and (ρ,φ) and with the introduction of the scaleX parameter, the (ρ,φ)→(s,t) mapping is a straightforward task:

$$t = - {w}_{1} \cdot tan ( - φ ) ,$$

$$s = \frac{ρ}{scaleX \cdot {w}_{1}} \cdot \sqrt{{t}^{2} + {w}_{1}^{2}} , when - 45 ° \leq φ < 45 °$$

$$t = - {w}_{1} / tan ( φ ) ,$$

$$s = \frac{ρ}{scaleX \cdot {w}_{1}} \cdot \sqrt{{t}^{2} + {w}_{1}^{2}} , when 45 ° \leq φ < 135 °$$

These equations are given without considering the shift for each of the four image quadrants.

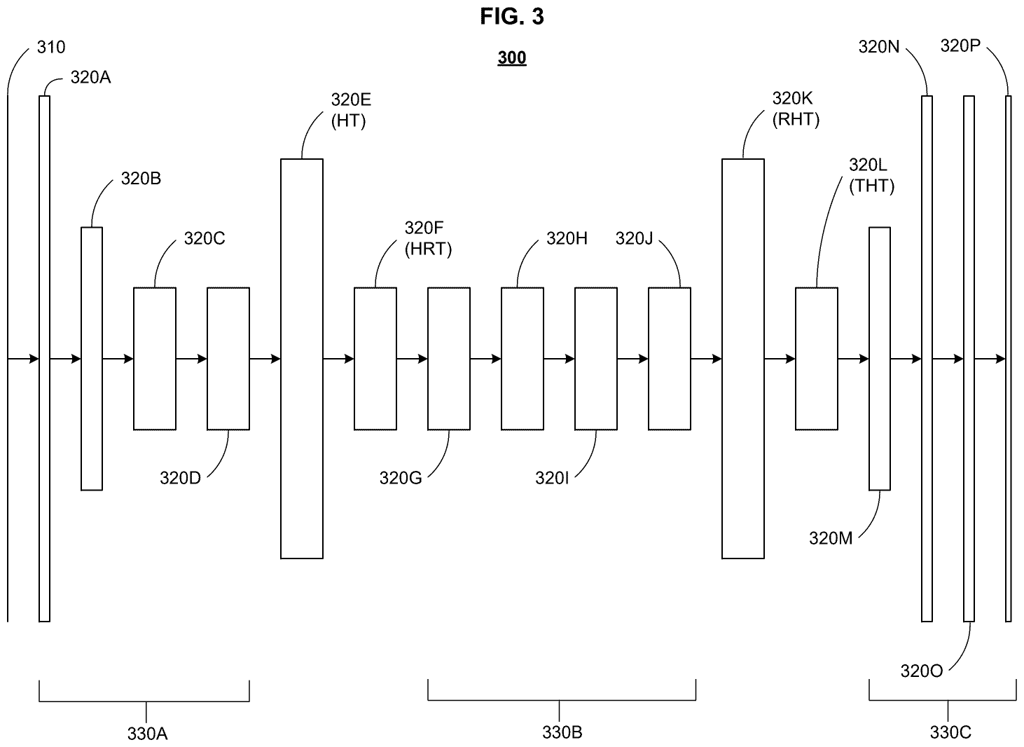

FIG. 3 illustrates an example architecture of an artificial neural network 300 with an HRT layer 320F, according to an embodiment. It should be understood that HRT layer 320F implements the described Hough-to-Radon Transform to convert from the (s,t) parameter space to the (ρ,φ) parameter space. In addition, a Radon-to-Hough Transform (RHT) layer 320K, which implements the transpose of the Hough-to-Radon Transform, may be added to artificial neural network 300 to convert from the (ρ,φ) parameter space back to the (s,t) parameter space. RHT layer 320K may also be utilized for gradient propagation during training of artificial neural network 300. HRT layer 320F and RHT layer 320K have no trainable parameters, and therefore, do not add to the number of weights of artificial neural network 300. All operations in HRT layer 320F and RHT layer 320K may be predefined and kept constant during training of artificial neural network 300.

The illustrated architecture of artificial neural network 300 was implemented for the experiments described elsewhere herein. The base architecture (i.e., without HRT layer 320F and RHT layer 320K) is that of a HoughEncoder, as described in Ref10. In a HoughEncoder, an artificial neural network 300 is used as an autoencoder for semantic segmentation of images of documents, to produce an image in the same coordinate space. The layers that follow the FHT layer in a HoughEncoder cannot translate the resulting Hough image into a different parameter space, since this would affect physical meaning. Thus, RHT layer 320K is added after HRT layer 320F to reverse the conversion from the first parameter space into the second parameter space that was performed by HRT layer 320F. In other words, RHT layer 320K converts an image from the second parameter space back into the first parameter space.

Artificial neural network 300 accepts an input image 310 having a size of 256×256 (i.e., w₁=256), and comprises the following layers 320:

| | | | Activation |
|---|---|---|---|
| Layer | Type | Parameters | Func. |
| 320A | Conv. | 4 filters 3 × 3, stride 1 × 1, padding 1 × 1 | softsign |
| 320B | Conv. | 8 filters 3 × 3, stride 1 × 1, padding 1 × 1 | softsign |
| 320C | Conv. | 16 filters 3 × 3, stride 1 × 1, padding 1 × 1 | softsign |
| 320D | Conv. | 16 filters 3 × 3, stride 1 × 1, padding 1 × 1 | softsign |
| 320E | FHT | — | — |
| 320F | HRT | — | — |
| 320G | Conv. | 16 filters 3 × 3, stride 1 × 1, padding 1 × 1 | softsign |
| 320H | Conv. | 16 filters 3 × 3, stride 1 × 1, padding 1 × 1 | softsign |
| 320I | Conv. | 16 filters 3 × 3, stride 1 × 1, padding 1 × 1 | softsign |
| 320J | Conv. | 16 filters 3 × 3, stride 1 × 1, padding 1 × 1 | softsign |
| 320K | RHT | — | — |
| 320L | TFHT | — | — |
| 320M | Conv. | 8 filters 3 × 3, stride 1 × 1, padding 1 × 1, | softsign |
| | | upscale 2 × 2 | |
| 320N | Conv. | 4 filters 3 × 3, stride 1 × 1, padding 1 × 1, | softsign |
| | | upscale 2 × 2 | |
| 320O | Conv. | 4 filters 3 × 3, stride 1 × 1, padding 1 × 1 | softsign |
| 320P | Conv. | 2 filters 3 × 3, stride 1 × 1, padding 1 × 1 | softsign |

It should be understood that the illustrated artificial neural network 300 is simply one example. In practice, artificial neural network 300 may consist of any number of layers 320, having any number of filters, having any size of filter, stride, padding, and/or upscaling, and using any suitable activation function, operate on any size of input image, and/or the like. Disclosed embodiments incorporate at least one HRT layer 320F (e.g., immediately following HT layer 320E), and optionally, at least one RHT layer 320K (e.g., immediately preceding Transposed Hough Transform (THT) layer 320L). In a typical embodiment, artificial neural network 300 may comprise a first subset 330A of one or more layers 320 (e.g., four convolutional layers 320A, 320B, 320C, and 320D in the illustrated example), followed by HT layer 320E (e.g., an FHT layer), followed by HRT layer 320F, followed by a second subset 330B of one or more layers 320 (e.g., four convolutional layers 320G, 320H, 320I, and 320J in the illustrated example), followed by RHT layer 320K, followed by THT layer 320L (e.g., a TFHT layer), followed by a third subset 330C of one or more layers 320 (e.g., four convolutional layers 320M, 320N, 320O, and 320P in the illustrated example).

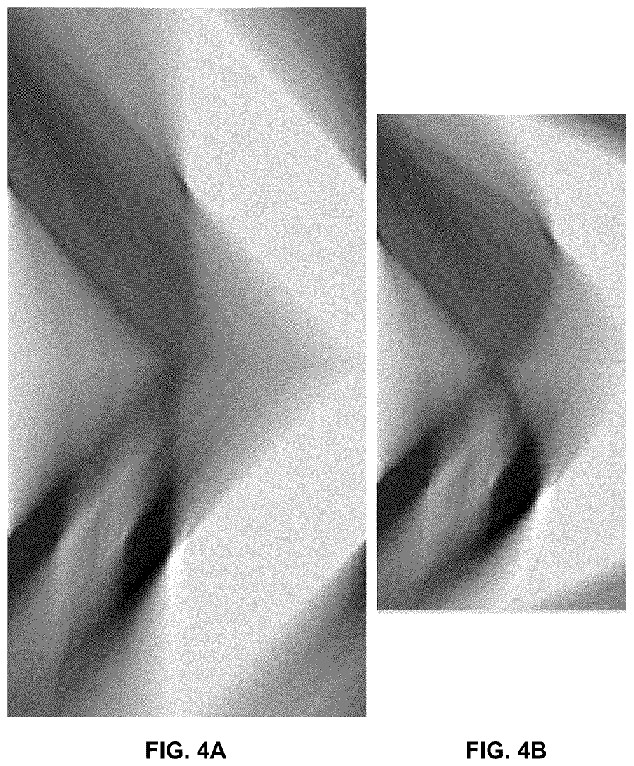

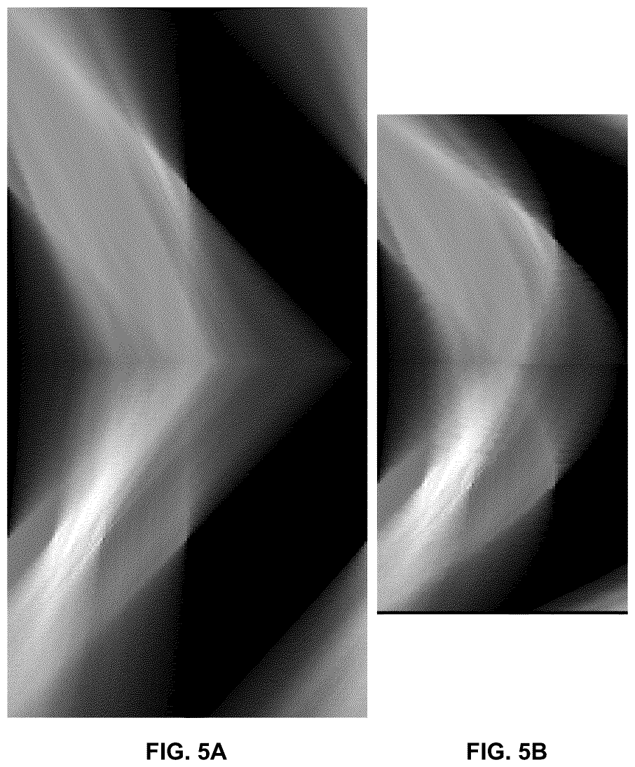

With such an architecture, the second subset 330B of layer(s) 320 (e.g., convolutional layers 320G-320J) works on smaller feature maps than it otherwise would following HT layer 320E. In other words, the utilization of HRT layer 320F reduces the size of the feature maps on which second subset 330B of layers 320 needs to work. This second subset 330B of layers 320 may also be referred to herein as “the inner layers.” As an example, FIG. 4A represents an output image after application of HT layer 320E alone, whereas FIG. 4B represents the same image after application of the combination of HT layer 320E and HRT layer 320F, at a consistent scale. Similarly, FIG. 5A represents an output image after application of HT layer 320E alone, whereas FIG. 5B represents the same image after application of the combination of HT layer 320E and HRT layer 320F, at a consistent scale. From these examples, it is evident that HRT layer 320F significantly reduces the sizes of the respective features maps.

### 4. Example Training Process

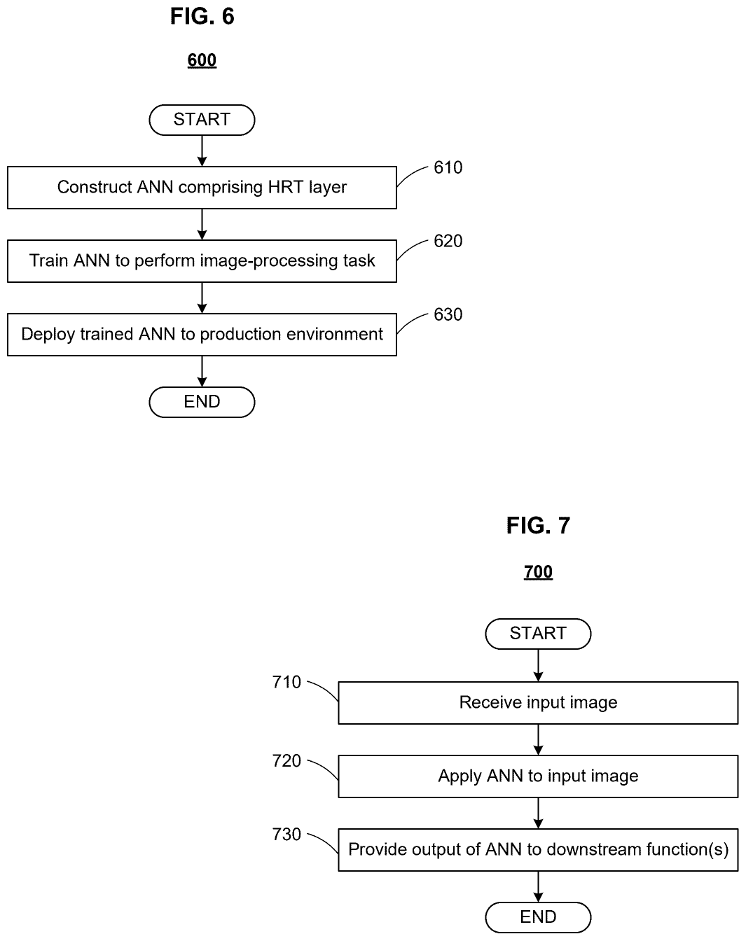

FIG. 6 illustrates a process 600 for training an artificial neural network 300, according to an embodiment. Process 600 may be implemented in software that is stored and executed by processing system 100, implemented entirely in hardware components (e.g., special-purpose processor, integrated circuit (IC), application-specific integrated circuit (ASIC), digital signal processor (DSP), field-programmable gate array (FPGA) or other programmable logic device, discrete gate or transistor logic, etc.), or implemented in a combination of software and hardware components. While process 600 is illustrated with a certain arrangement and ordering of subprocesses, process 600 may be implemented with fewer, more, or different subprocesses and a different arrangement and/or ordering of subprocesses. In addition, it should be understood that any subprocess, which does not depend on the completion of another subprocess, may be executed before, after, or in parallel with that other independent subprocess, even if the subprocesses are described or illustrated in a particular order.

In subprocess 610, an artificial neural network 300 is constructed. Artificial neural network 300 comprises a plurality of layers 320. The plurality of layers 320 includes an HT layer 320E that implements a Hough Transform (e.g., Fast Hough Transform) to convert an image into the first parameter space, and an HRT layer 320F that converts the image from the first parameter space into the second parameter space. As discussed elsewhere herein, the first parameter space defines each line in the image using (s,t) coordinates, in which s is a coordinate of a first intersection of the line with a first boundary of the image that is parallel to an axis of the image, and t is a difference along the axis between the first intersection and a second intersection of the line with a second boundary of the image that is parallel to the axis. The second parameter space, on the other hand, defines each line in the image using (ρ,φ) coordinates, in which ρ is a distance of the line from an origin point defined for the image, and o is an angle of a normal slope of the line. In an embodiment, HRT layer 320F immediately follows HT layer 320E in sequence from the input to the output of artificial neural network 300.

In an embodiment, the plurality of layers 320 further comprises RHT layer 320K that converts the image from the second parameter space back to the first parameter space, and a THT layer 320L that implements a Transposed Hough Transform (e.g., Transposed Fast Hough Transform). In an embodiment, THT layer 320L immediately follows RHT layer 320K in sequence from the input to the output of artificial neural network 300. It should be understood that RHT layer 320K will follow HRT layer 320F in the sequence of artificial neural network 300, generally with one or more layers 320 therebetween, and that THT layer 320L will follow HT layer 320E in the sequence, with HRT layer 320F and RHT layer 320K therebetween.

The plurality of layers 320 may further comprise one or more layers 320 between HRT layer 320F and RHT layer 320K, such as subset 330B comprising layers 320G-320J. In addition, the plurality of layers 320 may comprise one or more layers 320 before HT layer 320E, such as subset 330A comprising layers 320A-320D, and/or one or more layers 320 after THT layer 320L, such as subset 330C comprising layers 320M-320P. Layers 320 in subsets 330A, 330B, and/or 330C may be convolutional layers. In other words, artificial neural network 300 may be a convolutional neural network (CNN) that comprises HT layer 320E and HRT layer 320F, and optionally RHT layer 320K and THT layer 320L.

In subprocess 620, artificial neural network 300, including HT layer 320E and HRT layer 320F, and potentially RHT layer 320K and THT layer 320L, is trained to perform an image-processing task, such as image segmentation (e.g., semantic document segmentation, for example, of identity documents). Artificial neural network 300 may be trained in any well-known manner. For example, the weights within one or more layers 320 (e.g., the convolutional layers) may be adjusted, over a plurality of training epochs, so as to minimize a loss function that calculates an error between actual outputs and target outputs of artificial neural network 300 during training. During training of artificial neural network 300, all operations in HRT layer 320F and/or RHT layer 320K may be predefined and kept constant. RHT layer 320K may be utilized for gradient propagation during training of artificial neural network 300. Subprocess 620 may include evaluating the trained artificial neural network 300 to ensure that is satisfies one or more performance criteria (e.g., achieves a threshold value of an accuracy metric), and potentially retraining artificial neural network 300 when the one or more performance criteria are not satisfied.

In subprocess 630, the trained artificial neural network 300 may be deployed to perform the image-processing task on each of a plurality of input images in a production environment. For example, the trained artificial neural network 300 may be made accessible via an application programming interface (API) at an address (e.g., in a microservices architecture), so that artificial neural network 300 is accessible to one or more applications. In this manner, the trained artificial neural network 300 may be utilized in a larger, overarching application, such as a software application for document recognition and/or verification (e.g., for identity documents).

### 5. Example Operating Process

FIG. 7 illustrates a process 700 for operating an artificial neural network 300, according to an embodiment. Process 700 may be implemented in software that is stored and executed by processing system 100 (e.g., the same or different processing system 100 as used for process 600), implemented entirely in hardware components (e.g., special-purpose processor, integrated circuit (IC), application-specific integrated circuit (ASIC), digital signal processor (DSP), field-programmable gate array (FPGA) or other programmable logic device, discrete gate or transistor logic, etc.), or implemented in a combination of software and hardware components. While process 700 is illustrated with a certain arrangement and ordering of subprocesses, process 700 may be implemented with fewer, more, or different subprocesses and a different arrangement and/or ordering of subprocesses. In addition, it should be understood that any subprocess, which does not depend on the completion of another subprocess, may be executed before, after, or in parallel with that other independent subprocess, even if the subprocesses are described or illustrated in a particular order.

In subprocess 710, an input image 310 is received. For example, a service that interfaces with or comprises artificial neural network 300 may receive input image 310 via an API of that service. Alternatively, the service that interfaces with or comprises artificial neural network 300 may retrieve input image 310 from a data source (e.g., via an API of that data source). In the case of semantic document segmentation, input image 310 may be an image of a document, such as an identity document (e.g., passport, drivers license, etc.) that identifies an owner of the document.

In subprocess 720, the trained artificial neural network 300, deployed in subprocess 630, is applied to the input image 310 that was received in subprocess 710, to perform the image-processing task for which artificial neural network 300 was trained. In particular, input image 310 may be input to a first layer 320 (e.g., 320A) of artificial neural network 300, to produce an output from the final layer 320 (e.g., 320P) of artificial neural network 300. This output represents the result of the image-processing task performed by the trained artificial neural network 300.

As input image 310 traverses artificial neural network 300, input image 310 will be processed by HT layer 320E and HRT layer 320F. HRT layer 320F may generate an output image of a predefined size by, for each (ρ,φ) coordinate in the output image, setting a value of a pixel at that (ρ,φ) coordinate in the output image based on a value (e.g., as the value) of a pixel at a corresponding (s,t) coordinate in the image produced by HT layer 320E. The predefined size may be defined by a height equal to a number of angles (e.g., h₂=n), acquired from a range of angles (e.g., [−45°; 135°]) according to a step size (e.g., 180/n), and a width equal to a maximum integer radius in input image 310 prior to application of HT layer 320E (e.g., w₂=\sqrt{2w₁²}). As discussed elsewhere herein, (s,t) coordinates in the first parameter space may be mapped to (ρ,φ) coordinates in the second parameter space as follows:

$$t = - {w}_{1} \cdot tan ( - φ ) ,$$

$$s = \frac{ρ}{scaleX \cdot {w}_{1}} \cdot \sqrt{{t}^{2} + {w}_{1}^{2}} , when - 45 ° \leq φ < 45 °$$

$$t = - {w}_{1} / tan ( φ ) ,$$

$$s = \frac{ρ}{scaleX \cdot {w}_{1}} \cdot \sqrt{{t}^{2} + {w}_{1}^{2}} , when 45 ° \leq φ < 135 °$$

wherein w₁ is a width of input image 310, tan(·) is the tangent function, and scaleX is a scaling factor.

In subprocess 730, the output of the trained artificial neural network 300 is provided to to one or more downstream functions. This output may be the raw or post-processed output of trained artificial neural network 300 for the input image 310 that was received in subprocess 710. For example, if the image-processing task, for which artificial neural network 300 was trained, comprises image segmentation, artificial neural network 300 may output a classification of each pixel in input image 310 into one of a plurality of classes, with each of the plurality of classes representing a different type of segment. In the case of semantic document segmentation, the plurality of classes may comprise or consist of a background class (e.g., representing a background in input image 310) and a foreground class (e.g., representing the identity or other type of document in input image 310).

The downstream function(s) may comprise any function that may utilize the output of artificial neural network 300. For example, if the image-processing task is image segmentation, the downstream function(s) may utilize the image segmentation for computer vision. In the case of semantic document segmentation for an identity document, the downstream function(s) may represent a software application that recognizes the identity document, extracts data from the identity document, and/or verifies the authenticity of the identity document.

### 6. Experimental Results

Experiments were conducted using the architecture of artificial neural network 300, described above, in order to measure the effectiveness and efficiency of HRT layer 320F when added to an existing HoughEncoder architecture. The aim of the experiments was to estimate the properties of artificial neural network 300, such as the error value and the number of operations performed by the inner layers 320 (e.g., subset 330B of convolutional layers 320G-320J), while modifying the input parameters n and scaleX of HRT layer 320F. All of the artificial neural networks 300, which were tested, were trained for one-hundred epochs under the same conditions, using the most common image distortions (e.g., noise, highlights, straight lines, blur, darkening, etc.). For reference, these artificial neural networks 300 were also compared against an existing HoughEncoder that did not include a Hough-to-Radon Transform.

For the experiments, the Mobile Identity Document Video (MIDV)-500 dataset was used. The MIDV-500 dataset, which is described in Ref17, is an open dataset that contains images of fifty different types of documents, captured at different angles with complex lightings and backgrounds, and the coordinates of the corners of each document in each image. The first thirty document types were used to train artificial neural networks 300, and the remaining twenty document types were used to test artificial neural networks 300. Only images that contained at least three corners of the document were used. Each of these images was converted to grayscale and scaled to a size of 256×256 (i.e., w₁=256). The total number of images used was 11,965, with the test set consisting of 4,748 of those images.

In order to compare the accuracies of artificial neural networks 300, the mean intersection over union (MIOU) was calculated for each artificial neural network 300, as follows:

$$MIoU = \frac{1}{N} {\sum }_{i = 0}^{N - 1} \frac{{A}_{i} ⋂ {G}_{i}}{{A}_{i} ⋃ {G}_{i}}$$

wherein N is the number of classes (e.g., N=2, representing background and foreground classes), Aᵢ is the output of the artificial neural network 300 for the given class i, and G; is the ground-truth for the given class i.

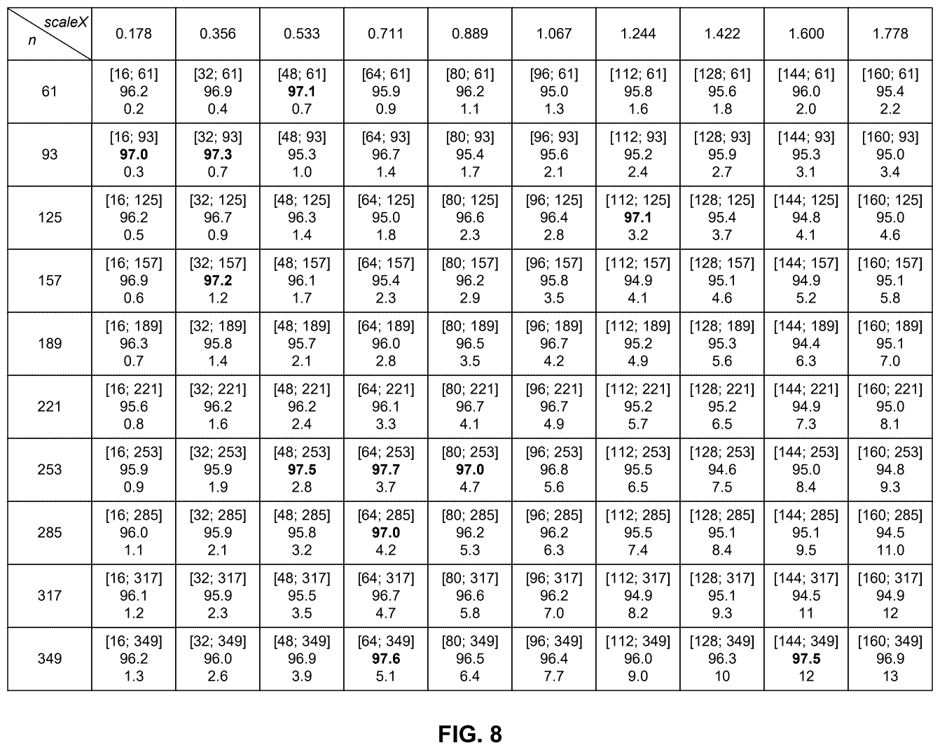

FIG. 8 is a table of the results of the experiments for different values of n and scaleX, according to an implementation of an embodiment. The top value in each cell represents the size of the feature maps for the given n and scaleX. The middle value in each cell represents the MIoU of the given artificial neural network 300 for the given n and scaleX. Values of MIoU that are greater than or equal to 97.0% have been highlighted in bold. The bottom value in each cell represents the number of operations performed by the inner layers (i.e., subset 330B) in units of 107.

These results demonstrate that HRT layer 320F and RHT layer 320K serve their purpose by allowing artificial neural network 300 to solve the task with fewer operations. The use of the parameters n and scaleX enable the size of the input image to be varied within a wide range of values to optimize the computational complexity. A comparison of the MIoU values proves that decreasing the sizes of intermediate feature maps does not always result in a loss of quality. It can be seen that the number of operations can be reduced by 97% with an increase in accuracy of 0.2% over the basic HoughEncoder. Artificial neural network 300 can provide the same quality with different numbers of operations. Thus, there is no need to perform more operations to solve the task. Furthermore, it is clear from the results that the disclosed embodiments not only save time and reduce memory requirements, but also boost the accuracy of segmentation from 96% (see Ref10) up to 97.7%.

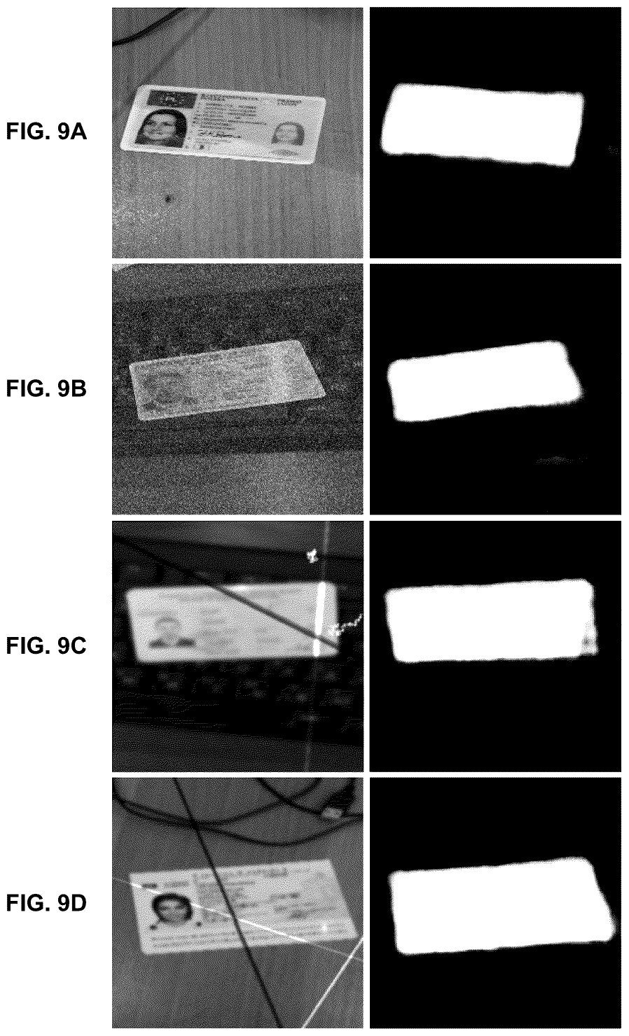

FIGS. 9A-9D illustrate the results of semantic document segmentation, produced by an artificial neural network 300 comprising HRT layer 320F and RHT layer 320K, according to several examples. In each example, input image 310 is illustrated on the left, and the resulting image with semantic document segmentation is illustrated on the right. In this case, each pixel in input image 310 has been classified as either background (i.e., represented by black) or foreground (i.e., represented by white).

### 7. References

Each of the following references are hereby incorporated herein by reference as if set forth in full:
Ref1: Li, Q., Cai, W., Wang, X., Zhou, Y., Feng, D. D., and Chen, M. (2014) “Medical image classification with convolutional neural network”, 2014 13th International Conference on Control Automation Robotics & Vision (ICARCV), Singapore. doi: 10.1109/ICARCV.2014.7064414;
Ref2: Jiang Y, Chen L, Zhang H and Xiao X (2019) “Breast cancer histopathological image classification using convolutional neural networks with small SE-ResNet module”, PLOS ONE 14 (3): e0214587. doi: 10.1371/journal.pone.0214587;
Ref3: Bruno D. R., Osorio F. S. (2017) “Image classification system based on deep learning applied to the recognition of traffic signs for intelligent robotic vehicle navigation purposes”, Latin American Robotics Symposium (LARS) and 2017 Brazilian Symposium on Robotics (SBR), Curitiba, Brazil. doi: 10.1109/SBR-LARS-R.2017.8215287;
Ref4: Madan R., Agrawal D., Kowshik S., Maheshwari H., Agarwal S., and Chakravarty D. (2019) “Traffic Sign Classification using Hybrid HOG-SURF Features and Convolutional Neural Networks”, in ICPRAM. doi: 10.5220/0007392506130620;
Ref5: Lecun Y., Bottou L., Bengio Y. and Haffner P. (1998) “Gradient-based learning applied to document recognition”, in Proceedings of the IEEE, doi: 10.1109/5.726791;
Ref6: Jnawali K., Arbabshirani M. R., Rao N., and Patel A. A. (2018) “Deep 3D convolution neural network for CT brain hemorrhage classification”, Proc. SPIE 10575, Medical Imaging 2018: Computer-Aided Diagnosis; doi: 10.1117/12.2293725;
Ref7: Sheshkus A., Ingacheva A., and Nikolaev D. (2018) “Vanishing points detection using combination of fast Hough transform and deep learning”, Proc. SPIE 10696, Tenth International Conference on Machine Vision (ICMV 2017); doi: 10.1117/12.2310170;
Ref8: Prun V. E., Nikolaev D. P., Buzmakov A. V. et al. (2013) “Effective regularized algebraic reconstruction technique for computed tomography”, Crystallogr. doi: 10.1134/S1063774513070158;
Ref9: Karpenko S., Nikolaev D. (2008) â€œHough Transform: Underestimated Tool In The Computer Vision Fieldâ€., 22nd European Conference on Modelling and Simulation, ECMS 2008. doi: 10.7148/2008-0238;
Ref10: Sheshkus A., Nikolaev D., and Arlazarov V. (2020) “Houghencoder: Neural Network Architecture for Doc-ument Image Semantic Segmentation”, 2020 IEEE International Conference on Image Processing (ICIP). doi: 10.1109/ICIP40778.2020.9191182;
Ref11: Aliev M., Ershov E. I., and Nikolaev D. P. (2018) “On the use of FHT, its modification for practical applications and the structure of Hough image”, International Conference on Machine Vision. ArXiv: 1811.06378;
Ref12: M. A. Aliev, D. P. Nikolaev, A. A. Saraev (2014) “Construction of fast computing adjustment for Niblack binarization algorithm”, ISA RAN V. 64.3. P. 25-34;
Ref13: Ballard D. H. (1981) “Generalizing the Hough transform to detect arbitrary shapes”, Pattern Recognition, 13.2, ISSN 0031-3203. doi: 10.1016/0031-3203 (81) 90009-1;
Ref14: Ershov E. I. (2017) “Generation Algorithms Of Fast Generalized Hough Transform”, 31st European Conference on Modelling and Simulation, ISBN: 978-0-9932440 April 9;
Ref15: Sheshkus A. V., Ingacheva A., Arlazarov V. L., and Nikolaev D. P. (2019) “HoughNet: Neural Network Architecture for Vanishing Points Detection”, 2019 International Conference on Document Analysis and Recognition (ICDAR). doi: 10.1109/ICDAR.2019.00140;
Ref16: Dolmatova A. V., Nikolaev D. P. “Uskorenie svertki i obratnogo proetsirovaniya pri rekonstruktsii tomograficheskikh izobrazhenii” [Fast filtering and back projection for CT image reconstruction]. Sensornye sistemy [Sensory systems]. 2020. V. 34 (1). P. 64-71 (in Russian). doi: 10.31857/S0235009220010072;
Ref17: Arlazarov V. V., Bulatov K. B., and Chernov T. S. (2018) “MIDV-500: A Dataset for Identity Documents Analysis and Recognition on Mobile Devices in Video Stream”. ArXiv: 1807.05786;
Ref18: ShylajaS. S., Murthy K. N., and Natarajan, S. (2011) “Feed Forward Neural Network Based Eye Localization and Recognition Using Hough Transform”, International Journal of Advanced Computer Science and Applications, 2. doi: 10.14569/IJACSA.2011.020318;
Ref19: Wong A., and Bishop W. (2008) “Robust Hough-Based Symbol Recognition Using Knowledge-Based Hierarchical Neural Networks”, International Conference on Image Processing, Computer Vision, & Pattern Recognition. ISBN: 60132-078-7;
Ref20: Bailey D. G., Chang Y., and Moan S. L. (2020) “Analysing Arbitrary Curves from the Line Hough Transform”, Journal of Imaging, 6. doi: 10.3390/jimaging6040026;
Ref21: Goodfellow I., Bengio Y., and Courville A. (2016) “Deep Learning”, MIT Press, url: www.deeplearningbook.org; and
Ref22: Bichen Wu, Chenfeng Xu, Xiaoliang Dai, Alvin Wan, Peizhao Zhang, Masayoshi Tomizuk, Kurt Keutzer, Peter Va-jda. (2020) “Visual Transformers: Token-based Image Representation and Processing for Computer Vision”, Facebook AI, UC Berkeley. ArXiv: 2006.03677v4.

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

As used herein, the terms “comprising,” “comprise,” and “comprises” are open-ended. For instance, “A comprises B” means that A may include either: (i) only B; or (ii) B in combination with one or a plurality, and potentially any number, of other components. In contrast, the terms “consisting of,” “consist of,” and “consists of” are closed-ended. For instance, “A consists of B” means that A only includes B with no other component in the same context.

Combinations, described herein, such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, and any such combination may contain one or more members of its constituents A, B, and/or C. For example, a combination of A and B may comprise one A and multiple B's, multiple A's and one B, or multiple A's and multiple B's.

What is claimed is:

1. A method comprising using at least one hardware processor to:
construct an artificial neural network comprising a plurality of layers, wherein the plurality of layers comprises a Hough Transform (HT) layer that implements a Hough Transform to convert an image into a first parameter space, and a Hough-to-Radon Transform (HRT) layer that converts the image from the first parameter space into a second parameter space,
wherein the first parameter space defines each line in the image using (s,t) coordinates, in which s is a coordinate of a first intersection of the line with a first boundary of the image that is parallel to an axis of the image, and t is a difference along the axis between the first intersection and a second intersection of the line with a second boundary of the image that is parallel to the axis, and
wherein the second parameter space defines each line in the image using (ρ,φ) coordinates, in which ρ is a distance of the line from an origin point defined for the image, and φ is an angle of a normal slope of the line; and
train the artificial neural network to perform an image-processing task.

2. The method of claim 1, further comprising using the at least one hardware processor to deploy the trained artificial neural network to perform the image-processing task on each of a plurality of input images in a production environment.

3. The method of claim 2, further comprising using the at least one hardware processor to, after deploying the trained artificial neural network:
receive one of the plurality of input images;
apply the trained artificial neural network to the received input image to perform the image-processing task on the received input image; and
provide an output of the trained artificial neural network to one or more downstream functions.

4. The method of claim 3, wherein the image-processing task comprises image segmentation.

5. The method of claim 4, wherein the image segmentation is semantic document segmentation.

6. The method of claim 5, wherein the artificial neural network outputs a classification of each pixel in the input image into one of a plurality of classes, wherein the plurality of classes comprises a background class and a foreground class.

7. The method of claim 1, wherein the HRT layer immediately follows the HT layer in sequence from an input to an output of the artificial neural network.

8. The method of claim 1, wherein the plurality of layers further comprises a Radon-to-Hough Transform (RHT) layer that converts the image from the second parameter space to the first parameter space, and a Transposed Hough Transform (THT) layer that implements a Transposed Hough Transform, wherein the RHT layer follows the HRT layer in sequence from an input to an output of the artificial neural network.

9. The method of claim 8, wherein the THT layer immediately follows the RHT layer in the sequence from the input to the output of the artificial neural network.

10. The method of claim 8, wherein the plurality of layers further comprises one or more layers between the HRT layer and the RHT layer.

11. The method of claim 10, wherein each of the one or more layers between the HRT layer and the RHT layer is a convolutional layer.

12. The method of claim 10, wherein the plurality of layers further comprises one or both of one or more layers before the HT layer, or one or more layers after the THT layer.

13. The method of claim 1, wherein the Hough Transform is a Fast Hough Transform.

14. The method of claim 1, wherein the artificial neural network is a convolutional neural network.

15. The method of claim 1, wherein the HRT layer generates an output image of a predefined size by, for each (ρ,φ) coordinate in the output image, setting a value of a pixel at that (ρ,φ) coordinate in the output image based on a value of a pixel at a corresponding (s,t) coordinate in an input image.

16. The method of claim 15, wherein the predefined size is defined by a height equal to a number of angles, acquired from a range of angles according to a step size, and a width equal to a maximum integer radius in the input image prior to application of the HT layer.

17. The method of claim 1, wherein (s,t) coordinates in the first parameter space are mapped to (ρ,φ) coordinates in the second parameter space as follows:
$$t = - {w}_{1} \cdot tan ( - φ ) ,$$
$$s = \frac{ρ}{scaleX \cdot {w}_{1}} \cdot \sqrt{{t}^{2} + {w}_{1}^{2}} , when - 45 ° \leq φ < 45 °$$
$$t = - {w}_{1} / tan ( φ ) ,$$
$$s = \frac{ρ}{scaleX \cdot {w}_{1}} \cdot \sqrt{{t}^{2} + {w}_{1}^{2}} , when 45 ° \leq φ < 135 °$$
wherein w₁ is a width of the image, tan(·) is a tangent function, and scaleX is a scaling factor.

18. The method of claim 1, wherein all operations in the HRT layer are predefined and kept constant during the training of the artificial neural network.

19. A system comprising:
at least one hardware processor; and
software that is configured to, when executed by the at least one hardware processor,
construct an artificial neural network comprising a plurality of layers, wherein the plurality of layers comprises a Hough Transform (HT) layer that implements a Hough Transform to convert an image into a first parameter space, and a Hough-to-Radon Transform (HRT) layer that converts the image from the first parameter space into a second parameter space,
wherein the first parameter space defines each line in the image using (s,t) coordinates, in which s is a coordinate of a first intersection of the line with a first boundary of the image that is parallel to an axis of the image, and t is a difference along the axis between the first intersection and a second intersection of the line with a second boundary of the image that is parallel to the axis, and
wherein the second parameter space defines each line in the image using (ρ,φ) coordinates, in which ρ is a distance of the line from an origin point defined for the image, and φ is an angle of a normal slope of the line, and
train the artificial neural network to perform an image-processing task.

20. A non-transitory computer-readable medium having instructions stored therein, wherein the instructions, when executed by a processor, cause the processor to:
construct an artificial neural network comprising a plurality of layers, wherein the plurality of layers comprises a Hough Transform (HT) layer that implements a Hough Transform to convert an image into a first parameter space, and a Hough-to-Radon Transform (HRT) layer that converts the image from the first parameter space into a second parameter space,
wherein the first parameter space defines each line in the image using (s,t) coordinates, in which s is a coordinate of a first intersection of the line with a first boundary of the image that is parallel to an axis of the image, and t is a difference along the axis between the first intersection and a second intersection of the line with a second boundary of the image that is parallel to the axis, and
wherein the second parameter space defines each line in the image using (ρ,φ) coordinates, in which ρ is a distance of the line from an origin point defined for the image, and φ is an angle of a normal slope of the line; and
train the artificial neural network to perform an image-processing task.
